(19) United States
(12) Patent Application Publication
(10) Pub. No.: US 2025/0287156 A1
(43) Pub. Date: Sep. 11, 2025

(54) RADIAL MEMS COMPONENTS FOR AUDIO TRANSDUCERS

(71) Applicant: Apple Inc., Cupertino, CA (US)

(72) Inventors: Gokhan HATIPOGLU, Milpitas, CA (US); Onur I. ILKORUR, Santa Clara, CA (US); Peter C. HRUDEY, San Jose, CA (US)

(21) Appl. No.: 19/046,462

(22) Filed: Feb. 5, 2025

Related U.S. Application Data
(60) Provisional application No. 63/563,274, filed on Mar. 8, 2024.

(51) Int. Cl. H04R 19/02; H04R 1/02

(52) U.S. Cl. CPC H04R 19/02; H04R 1/028; H04R 2201/003; H04R 2400/11; H04R 2499/15

(57) ABSTRACT

Aspects of the subject technology relate to electronic devices having speakers such as microelectromechanical systems (MEMS) speakers. A MEMS speaker can include a radial MEMS component. The radial MEMS component may include an inner support structure, an outer support structure, and radial fins extending from the inner support structure to the outer support structure.

### CROSS REFERENCE TO RELATED APPLICATIONS

This application claims the benefit of priority to U.S. Provisional Patent Application No. 63/563,274, entitled, “Radial Mems Components For Audio Transducers”, filed on Mar. 8, 2024, the disclosure of which is hereby incorporated herein in its entirety.

### TECHNICAL FIELD

The present description relates generally to electronic devices including, for example, to microelectromechanical systems (MEMS) speakers.

### BACKGROUND

Electronic devices such as computers, media players, cellular telephones, wearable devices, and headphones are often provided with speakers for generating sound output from the device. However, particularly as devices are implemented in ever smaller form factors, and as user demand for high quality audio increases, it can be challenging to provide speakers that generate high quality sound, particularly in compact devices such as portable electronic devices.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates a perspective view of an example electronic device having a MEMS speaker in accordance with various aspects of the subject technology.

FIG. 2 illustrates a cross-sectional side view of a portion of an example electronic device having a MEMS speaker in accordance with various aspects of the subject technology.

FIG. 3 illustrates a cross-sectional side view of another example electronic device having a MEMS speaker in accordance with various aspects of the subject technology.

FIGS. 4A and 4B illustrate schematic cross-sectional side views of example MEMS speakers in accordance with various aspects of the subject technology.

FIG. 5 illustrates top view of an example MEMS component for a MEMS speaker in accordance with various aspects of the subject technology.

FIG. 6 illustrates a top view of a portion of the MEMS component of FIG. 5 illustrating actuation of the MEMS component for generating sound in accordance with various aspects of the subject technology.

FIG. 7 illustrates a bottom view of an example MEMS speaker with a bottom substrate removed in accordance with various aspects of the subject technology.

FIG. 8 illustrates a bottom view of another example MEMS speaker with a bottom substrate removed in accordance with various aspects of the subject technology.

FIG. 9 illustrates a bottom view of yet another MEMS speaker with a bottom substrate removed in accordance with various aspects of the subject technology.

FIGS. 10A and 10B illustrate a schematic cross-sectional side views of other example MEMS speakers in accordance with various aspects of the subject technology.

FIG. 11 illustrates a top view of a portion of a MEMS component showing an example implementation of a drive mechanism for the MEMS component in accordance with various aspects of the subject technology.

FIG. 12 illustrates a top view of a portion of a MEMS component showing another example implementation of a drive mechanism for the MEMS component in accordance with various aspects of the subject technology.

FIG. 13 illustrates a top view of a portion of a MEMS component showing yet another example implementation of a drive mechanism for the MEMS component in accordance with various aspects of the subject technology.

FIG. 14 illustrates a top view of a portion of a MEMS component showing still another example implementation of a drive mechanism for the MEMS component in accordance with various aspects of the subject technology.

FIG. 15 illustrates a flow diagram of an example process for operating a MEMS speaker having a radial MEMS component in accordance with one or more implementations.

FIG. 16 illustrates an electronic system with which one or more implementations of the subject technology may be implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

Portable electronic devices such as a mobile phones, portable music players, smart watches, tablet computers, laptop computers, other wearable devices, headphones, earbuds, and the like often include a speaker for generating sound.

In accordance with various aspects of the subject disclosure, a speaker is provided that includes a radial MEMS component. In one or more implementations, the radial MEMS component may include fins that extend radially from an inner cylindrical support structure to an outer cylindrical support structure. The inner cylindrical support structure and/or outer cylindrical support structure may be rotated (e.g., back and forth) to move the fins to generate sound for the MEMS speaker.

An illustrative electronic device including a speaker is shown in FIG. 1. In the example of FIG. 1, device 100 (e.g., an electronic device) has been implemented using a housing that is sufficiently small to be portable and carried by a user (e.g., device 100 of FIG. 1 may be a handheld electronic device such as a tablet computer or a cellular telephone or smart phone). As shown in FIG. 1, device 100 includes a display such as display 110 mounted on the front of housing 106. Device 100 includes one or more input/output devices such as a touch screen incorporated into display 110, a button or switch and/or other input output components disposed on or behind display 110 or on or behind other portions of housing 106. Display 110 and/or housing 106 include one or more openings to accommodate button, a speaker, a light source, or a camera.

In the example of FIG. 1, housing 106 includes two openings 108 on a bottom sidewall of the housing. One or more of openings 108 forms a port for an audio component. For example, one of openings 108 may form a speaker port for a speaker disposed within housing 106 and another one of openings 108 may form a microphone port for a microphone disposed within housing 106. Openings 108 may be open ports or may be completely or partially covered with a permeable membrane or a mesh structure that allows air and sound to pass through the openings. Although two openings 108 are shown in FIG. 1, this is merely illustrative. One opening 108, two openings 108, or more than two openings 108 may be provided on the bottom sidewall (as shown) on another sidewall (e.g., a top, left, or right sidewall), on a rear surface of housing 106, and/or a front surface of housing 106. In some implementations, one or more groups of openings 108 in housing 106 may be aligned with a single port of an audio component within housing 106. Housing 106, which may sometimes be referred to as a case, may be formed of plastic, glass, ceramics, fiber composites, metal (e.g., stainless steel, aluminum, etc.), other suitable materials, or a combination of any two or more of these materials.

As shown, one or more openings 111 may be provided in the display 110. For example, the opening 111 may form a port for an audio component. For example, the opening 111 may form a speaker port for a speaker disposed within the housing 106 (e.g., behind the display 110). Opening 111 may be an open port or may be completely or partially covered with a permeable membrane or a mesh structure that allows air and sound to pass through the opening.

The configuration of device 100 of FIG. 1 is merely illustrative. In other implementations, device 100 may be a computer such as a computer that is integrated into a display such as a computer monitor, a laptop computer, a smaller portable device such as a smart watch, a pendant device, or other wearable or miniature device, a media player, a gaming device, a navigation device, a computer monitor, a television, a headphone, an earbud, or other electronic equipment. In some implementations, device 100 may be provided in the form of a computer integrated into a computer monitor. Display 110 may be mounted on a front surface of housing 106 and a stand may be provided to support housing (e.g., on a desktop).

In some implementations, device 100 may be provided in the form of a wearable device such as a smart watch. In one or more implementations, housing 106 may include one or more interfaces for mechanically coupling housing 106 to a strap or other structure for securing housing 106 to a wearer. It should be appreciated that, although device 100 includes one opening in the example of FIG. 1, device 100 may include one, two, three, four, or more than four openings. Device 100 may include one, two, three, or more than three audio components each mounted adjacent to one or more of openings 108 and/or 111.

A speaker disposed within housing 106 may transmit sound through an associated opening 108 or 111. A microphone may also be provided within housing 106 that receives sound through at least one associated opening in the housing. In one or more implementations, the speaker may be implemented as a microelectromechanical systems (MEMS) speaker.

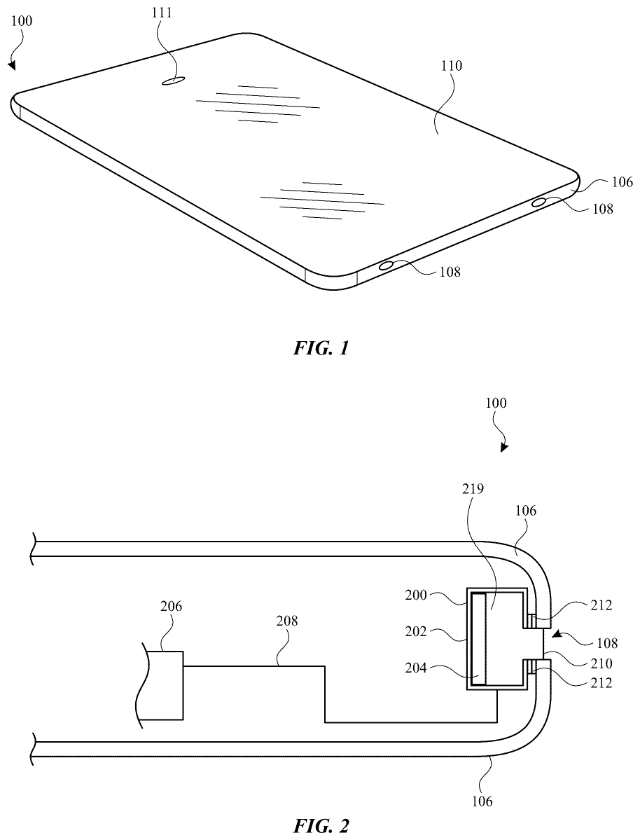

FIG. 2 illustrates a cross-sectional view of a portion of device 100 in which an audio component is mounted. In the example of FIG. 2, device 100 includes speaker 200. Speaker 200 includes speaker housing 202 mounted adjacent at least one opening 108 in housing 106. Speaker housing 202 may be formed form one or more materials such as plastic, metal, and/or a MEMS material. As shown, speaker 200 may include a MEMS transducer 204, which may be disposed within and/or form a part or all of the speaker housing 202. As discussed in further detail hereinafter, the MEMS transducer 204 may include a radial MEMS component. As shown in FIG. 2, the MEMS transducer 204 may be mounted within the speaker housing 202. In one or more implementations, a front volume 219 (e.g., as defined by the speaker housing 202 and/or one or more portions of the housing 106) may be provided within the speaker housing 202 in front of the MEMS transducer 204.

As illustrated in FIG. 2, speaker housing 202 may include an opening that is aligned with opening 108 in housing 106 so that sound generated by MEMS transducer 204 (e.g., responsive to control signals received from device circuitry 206) can be transmitted through the opening 108 to the external environment. Opening 108 may be an open port or may include a cover 210 such as a membrane or a mesh structure that discourages entry of liquid into speaker housing 202, but that is permeable to sound and air.

Speaker 200 (e.g., a MEMS speaker including MEMS transducer 204) may be communicatively coupled to device circuitry such as device circuitry 206 (e.g., one or more processors of the device) via a connector 208. Connector 208 may include a flexible integrated circuit or another flexible or rigid conductive connector. In one or more implementations, connector 208 may electrically couple to one or more contacts on speaker housing 202 that are electrically coupled (e.g., via wire bonds or other conductive connections) to MEMS transducer 204. However, it should be appreciated that, in one or more implementations, MEMS transducer 204 may be provided without a separate speaker housing 202 (e.g., and coupled directly to connector 208 and/or device circuitry 206). In implementations in which MEMS transducer 204 is provided without a separate speaker housing, an outer layer (e.g., a top substrate) of the MEMS transducer 204 can be attached to an inner surface of housing 106 (e.g., by adhesive 212 or another coupling mechanism), mounted to a printed circuit (e.g., connector 208) within device 100, or otherwise mounted within housing 106 so as to project sound out of housing 106 through opening 108.

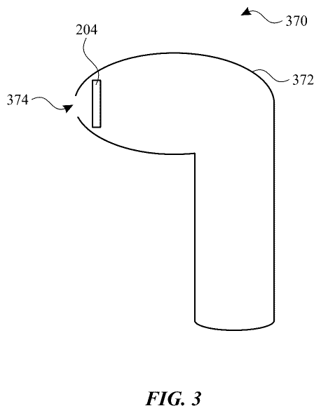

FIG. 3 illustrates a cross-sectional view of another example electronic device that may include a MEMS speaker. In the example of FIG. 3, a device 370 is implemented as an earbud having a MEMS speaker including or formed by a MEMS transducer 204. As shown, device 370 may include a housing 372 having a shape that is configured to fill the opening of an car canal of a user wearing the earbud. Device 370 may include one or more openings, such as an opening 374 in the housing 372. Housing 372 may have a size and a shape that conforms to a portion of an outer car, such that opening 374 may be aligned with the car canal of the user when the earbud is worn by the user, to allow sound generated by MEMS transducer 204 to enter the user's ear canal. Device 370 may be a wired or wireless earbud that communicates with a companion device such as device 100 of FIG. 1 to receive instructions and/or signals to operate the MEMS speaker corresponding to MEMS transducer 204 to generate sound. The housing 372 of device 370, a speaker housing within the housing 372, and/or various portions of the MEMS transducer 204 can form (e.g., define) a front volume for the speaker 200. In the examples of FIGS. 1-3, a single MEMS transducer 204 is provided in a speaker 200. However, in one or more other implementations, multiple MEMS transducers 204 (e.g., an array of MEMS transducers) may be provided in a single speaker 200. For example, the MEMS transducer 204 may be a first MEMS transducer unit in a speaker having a one or more additional MEMS transducer units (e.g., formed by one or more additional respective MEMS transducers 204 as described herein).

The electronic devices of FIGS. 1 and 3 are merely illustrative, and it should be appreciated that a MEMS speaker having MEMS transducer with a radial MEMS component as described herein can be implemented in any suitable electronic device for which it is desired to generate high quality sound from within a small volume. For example, a radial MEMS component may provide a large sound generating surface area (e.g., SD) with very small excursions (e.g., micron-scale excursions).

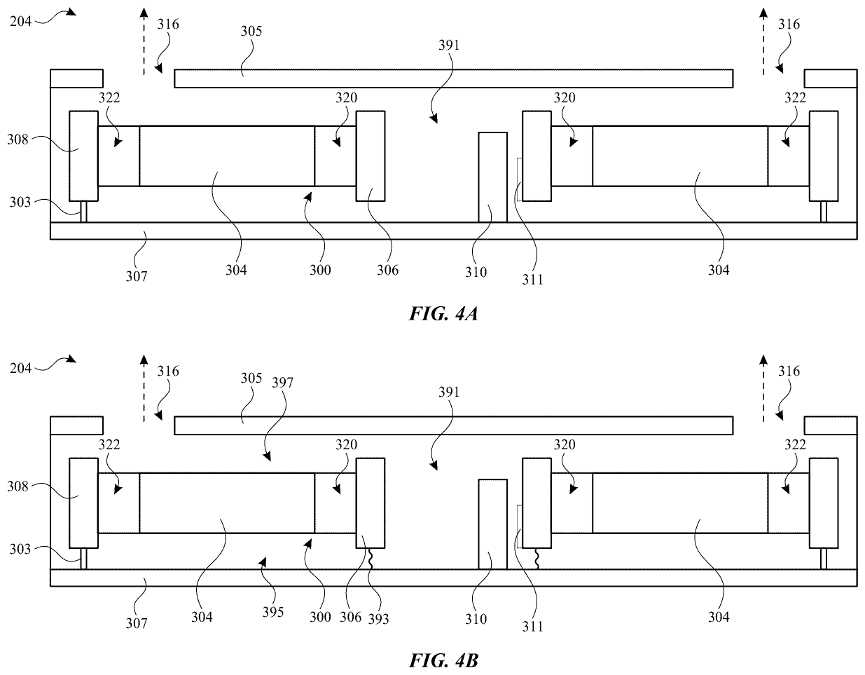

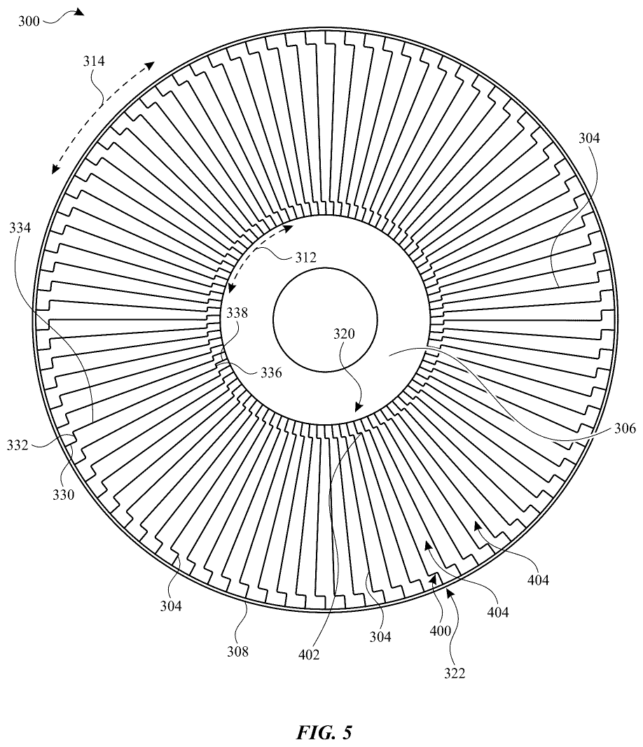

FIG. 4A shows a cross-sectional side view of a portion of an example MEMS transducer (also referred to as a MEMS actuator), which may be implemented in, or as, a MEMS speaker. In the example of FIG. 4A, the MEMS transducer includes a MEMS component 300. As shown, the MEMS component 300 may include an inner support structure 306, an outer support structure 308, and one or more fins, such as fin 304 (e.g., also referred to as blades). Each fin 304 may extend (e.g., in a substantially radial direction, as discussed in further detail hereinafter in connection with, for example, FIG. 5) from a first end 320 coupled to the inner support structure 306 to a second end 322 coupled to the outer support structure 308. In various implementations, at least one of the inner support structure 306 or the outer support structure 308 may rotate (e.g., back and forth) to actuate at least one of the first end 320 or the second end 322 of each of the fins 304 to generate sound (e.g., for the speaker 200). For example, actuating an end of each of the fins 304 may cause portions of adjacent ones of the fins 304 to move toward and away from each other, which may generate increases and decreases in pressure between the adjacent fins 304. These increases and decreases in pressure may move air to generate the sound for the speaker.

As described herein, the first end 320 of each of the fins 304 may be coupled to the inner support structure 306 and the second end 322 of each of the fins 304 may be coupled to the outer support structure 308. For example, fins 304 may be integral portions of a unitary structure that includes the inner support structure 306 and the outer support structure 308, or the ends of the fins 304 may be otherwise mechanically fixed to (e.g., attached to) the inner support structure 306 and the outer support structure 308.

In one example, with the first end 320 of each of the fins 304 coupled to the inner support structure 306 and the second end 322 of each of the fins 304 coupled to the outer support structure 308, rotating the inner support structure 306 causes the first end 320 of each of the fins 304 that are attached thereto to move (e.g., to move in a circumferential direction around an axis of the MEMS component 300) with the outer edge of the inner support structure 306. In this example, because the second ends 322 of the fins 304 are coupled to the outer support structure 308 which may be fixed in position, the second ends 322 remain fixed in position while the first ends 320 move as a result of being pulled (or pushed) in the circumferential direction by the rotating inner support structure 306. In this way, each of the fins 304 may be pivoted at the second end 322 thereof. This coordinated pivoting of the asymmetric radial fins 304 at the second ends 322 may cause the pressure variations (e.g., between the fins) that move air to generate the sound for the speaker.

In another example, with the first end 320 of each of the fins 304 coupled to the inner support structure 306 and the second end 322 of each of the fins 304 coupled to the outer support structure 308, rotating the outer support structure 308 causes the second end 322 of each of the fins 304 that are attached thereto to move (e.g., to move in a circumferential direction around an axis of the MEMS component 300) with the inner edge of the outer support structure 308. In this example, because the first ends 320 of the fins 304 are coupled to the inner support structure 306 which may be fixed in position, the first ends 320 remain fixed in position while the second ends 322 move as a result of being pulled (or pushed) in the circumferential direction by the rotating outer support structure 308. In this way, each of the fins 304 may be pivoted at the first end 320 thereof. This coordinated pivoting of the asymmetric radial fins 304 at the first ends 320 may cause the pressure variations (e.g., between the fins) that move air to generate the sound for the speaker.

In the example of FIG. 4A, the outer support structure 308 is fixed (e.g., by a beam 303 or other attachment), and the inner support structure 306 may be rotated to actuate the first ends 320 of the fins 304. For example, the MEMS transducer 204 may include a drive element 310 (e.g., including one or more electrodes configured to electrostatically interact with one or more electrodes 311 on the inner support structure 306 in this example) configured to drive the rotation of the inner support structure 306.

As shown in FIG. 4A, the MEMS transducer 204 may also include a first substrate 305 (e.g., a top substrate) on a first side of the MEMS component 300 and a second substrate 307 (e.g., a bottom substrate) on a second side of the MEMS component 300. The MEMS component 300 may be disposed within a cavity 391 defined, at least in part, by the first substrate 305 and the second substrate 307. In one or more implementations, the second substrate 307 may sealingly enclose the second side of the MEMS component 300. As shown, the first substrate 305 may include one or more openings 316. As shown, the openings 316 may be configured to allow sound generated by the fins 304 to exit (e.g., as indicated by the dashed arrows in FIG. 4) the MEMS transducer 204 (e.g., and the speaker 200).

In the example of FIG. 4A, air in the cavity 391 can flow between the fins 304 from the front side (e.g., a top side in the cross-sectional view of FIG. 4A) of the fins 304 across from which the first substrate 305 and the openings 316 are formed, and from a rear side (e.g., a bottom side in the cross-sectional view of FIG. 4A) of the fins 304 across from which the second substrate 307 is formed. FIG. 4B illustrates another example implementation of the MEMS transducer 204. As shown in FIG. 4B, in one or more implementations, a sealing feature 393 may be provided that (e.g., along with the beam 303) separates the cavity 391 into a back volume 395 on the rear side of the fins 304 and a front radiating cavity 397 on the front side of the fins 304. In the example of FIG. 4B, communication of the air between the fins 304 may have access to the cavity 391 only from the front side. In the example of FIG. 4B, the sealing feature 393 includes a flexible membrane that seals the back volume 395 while allowing rotation of the inner support structure 306. However, this is merely illustrative, and any other sealing feature or mechanism can be used that that seals the back volume 395 while allowing rotation of the inner support structure 306 (e.g., including forming a lower surface of the inner beam at a height above the second substrate 307 that prevents or restricts air from flowing between the lower surface of the inner beam and the second substrate 307). The implementation of FIG. 4B may be beneficial, for example, when implementing the MEMS transducer 204 to generate ultrasonic frequencies.

FIG. 5 illustrates a top view of the MEMS component 300 in accordance with one or more implementations. As shown in FIG. 5, the MEMS component 300 may be a radial MEMS component in which each of the fins 304 extends in a (e.g., substantially) radial direction from the inner support structure 306 to the outer support structure 308. For example, the radial directions along which the fins 304 extend in FIG. 5 may also be parallel to the first substrate 305 and the second substrate 307 (e.g., as depicted in FIG. 4).

As shown in FIG. 5, the inner support structure 306 may be a cylindrical inner support structure (e.g., having the circular cross-section show in FIG. 5) and the outer support structure 308 may be a cylindrical outer support structure (e.g., having the circular cross-section show in FIG. 5) positioned coaxially with (e.g., around) the cylindrical inner support structure. In one or more implementations, the outer support structure 308 may have a diameter of between 50 microns and 500 microns. As shown, the fins 304 may extend substantially radially from the cylindrical inner support structure to the cylindrical outer support structure. For example, a fin 304 may each include at least a portion (e.g., a portion 330, a portion 334, or a portion 338 as discussed in further detail hereinafter) that extends radially (e.g., along a radius) between the cylindrical inner support structure and the cylindrical outer support structure. For example, a fin 304 may include one or more jogs, radial discontinuities, or other changes in direction, such that the fin 304 has a first end 320 at the inner support structure 306, the second end 322 at the outer support structure 308, at least one radial portion between the first end 320 and the second end 322, and the entirety of the fin 304 is contained within a circumferential angular range (e.g., a circumferential angular range of less than five degrees, less than 3 degrees, or less than one degree).

As shown, a space 404 may be defined between each pair of adjacent fins 304. In one or more implementations, the MEMS component 300 may be a unitary contiguous structure including the inner support structure 306, the outer support structure 308, and the fins 304. MEMS component 300 may be formed from any of various materials including silicon, germanium, gallium arsenide, metals such as nickel and/or aluminum, polymers such as polyamide and/or photosensitive epoxies, and/or ceramics such as diamond, silicon dioxide, silicon carbide, silicon nitride, and/or other suitable MEMS materials.

The geometry of the fins 304 may be arranged to define a resonance frequency of the MEMS component 300 and the MEMS transducer 204. For example, FIG. 5 illustrates an example implementation in which one or more jogs, or radial discontinuities, in the fins 304 are provided to define a spring coefficient for the fins 304, and thereby to set the resonance frequency of the fins 304, the MEMS component 300, and the MEMS transducer 204. For example, the geometry of the fins 304 (e.g., the locations and/or sizes of one or more jogs or other radial discontinuities) may be arranged such that the MEMS transducer 204 has a resonance frequency above a certain value (e.g., between 8 kHz-12 kHz) for audio band operation, or at a specific value (e.g., a carrier frequency at 40 kHz or 200 kHz) for ultrasonic frequency generation.

For example, as shown in FIG. 5, each of the fins 304 may include a first jog 400 and a second jog 402. For example, each jog may include (e.g., moving radially along a fin in a radial direction along a first radius of the MEMS component) a first change in direction (e.g., away from the radial direction), and a second change in direction (e.g., back to the radial direction along a second radius, displaced circumferentially from the first radius, of the MEMS component). For example, each fin 304 may include a first radial portion 330 that extends from the outer support structure 308 along a first radius of the MEMS component 300 toward the inner support structure 306. The fin 304 may also include a first circumferential portion 332 that extends from the first radial portion 330 in a circumferential direction at a first radial distance from the inner support structure 306. The fin 304 may also include a second radial portion 334 that extends from first circumferential portion 332 along a second radius, circumferentially displaced from the first radius, of the MEMS component 300. The fin 304 may also include a second circumferential portion 336 that extends from the second radial portion 334 in a circumferential direction at a second radial distance from the inner support structure 306. The fin 304 may also include a third radial portion 338 that extends from second circumferential portion 336 to the inner support structure 306 along a third radius, circumferentially displaced from the first radius and the second radius, of the MEMS component 300. As shown, the second radial portion 334 of each fin 304 may be substantially longer (e.g., multiples longer, such as more than three times longer, more than five times longer, or more than ten times longer) than the first radial portion 330 and/or the third radial portion 338.

As shown, first jog 400 may be larger than the second jog 402. As shown, the first jog 400 may be nearer to the second end 322 than the first end 320, and the second jog 402 may be nearer to the first end 320 than the second end 322. In this way, each of the fins 304 may be provided with an asymmetric (e.g., lightning bolt-like) shape. The asymmetry in the fins 304 may cause, when the inner support structure 306 or the outer support structure 308 is rotated, the fins 304 to squeeze air into directions perpendicular to the fins 304 (e.g., parallel to cylindrical axis of the MEMS component 300) in a way that generates a desired sound (e.g., a sound corresponding to an input audio signal to a speaker including the MEMS component).

As illustrated in FIGS. 4A, 4B, and 5, the inner support structure 306 may be rotated (e.g., back and forth, as indicated by arrows 312). FIG. 5 also illustrates how, in some implementations, the outer support structure 308 may be rotated (e.g., back and forth, as indicated by arrows 314). The arrows 312 and 314 in FIG. 5 are exaggerated in size for visibility in the figure, and the actual rotations of the inner support structure 306 and/or the outer support structure 308 may be, for example, less than the distance between adjacent ones of the fins 304 (e.g., less than five degrees, less than three degrees, less than one degree, or approximately one degree), and large enough (e.g., more than 0.2 degree, more than 0.5 degrees, more than one degree, or approximately one degree) to move sufficient air to generate the desired sound.

In the example of FIG. 5, the fins 304 are arranged so that, when the inner support structure 306 or the outer support structure 308 is rotated, trapped air in the spaces 404 between the fins 304 will only generate higher pressures (e.g., increasingly higher pressures as the inner support structure 306 or the outer support structure 308 is rotated further from a neutral position) and will not drop to a negative (vacuum) value, whether the inner support structure 306 or the outer support structure 308 is rotated in a clockwise or counterclockwise direction. It is appreciated that the specific geometry of the fins 304 of FIG. 5 is illustrative, and other geometries and/or arrangements of MEMS structures can be provided that only generate higher pressures (e.g., increasingly higher pressures as the inner support structure 306 or the outer support structure 308 is rotated further from a neutral position) and will not drop to a negative (vacuum) value whether the inner support structure 306 or the outer support structure 308 is rotated in a clockwise or counterclockwise direction, to generate sound for a MEMS speaker.

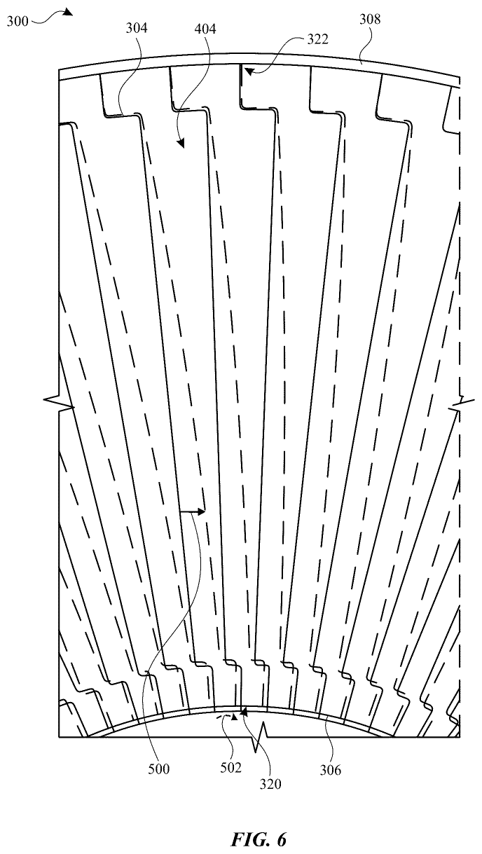

FIG. 6 illustrates a top view of a portion of the MEMS component 300 of FIG. 6 in an implementation in which the outer support structure 308 is fixed in position and the inner support structure 306 rotates, to actuate the fins 304 (e.g., as in the example of FIG. 4). In this example, the figure illustrates how the second ends 322 of the fins 304 may be held in place by the outer support structure 308 as the first ends 320 of the fins 304 are moved by the rotation of the inner support structure 306. In the example of FIG. 6, each of the fins 304 has moved (e.g., as indicated by arrow 500) into the space 404 between that fin 304 and an adjacent fin 304, due to a rotation 502 of the inner support structure 306. This movement of the fins 304 may cause air movement (e.g., due to an increase in pressure in the spaces 404) in a direction perpendicular to the arrow 500 (e.g., a direction parallel to the cylindrical axis of the MEMS component 300) to generate sound for the speaker 200. In order, for example, to compensate for leaky air movement (e.g., via the openings 316 in the first substrate 305 of FIG. 5), the MEMS component 300 may be designed and operated to stay above 115 dB across an audio band.

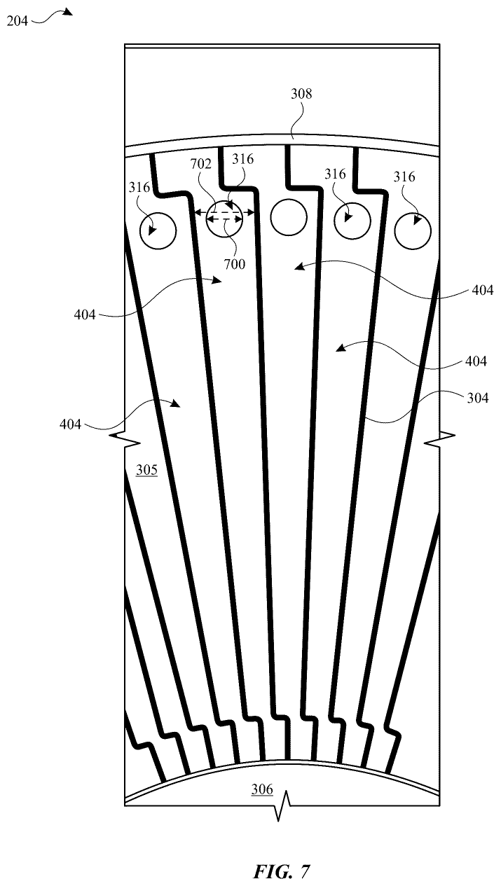

As discussed herein, the MEMS component 300 may be disposed between a pair of substrates (e.g., first substrate 305 and second substrate 307 of FIG. 4), in which one of the substrates includes openings to allow movement of air caused by the MEMS component 300. FIG. 7 illustrates a bottom view of a portion of the MEMS transducer 204 with the second substrate 307 removed. In this view, the openings 316 in the first substrate 305 can be seen between the fins 304.

As shown, the MEMS component 300 may include spaces 404, each space disposed between a pair of the fins 304, and the openings 316 in the first substrate 305 may include an opening 316 adjacent to (e.g., above) each of the spaces 404 in the MEMS component 300. In one or more implementations, at least some of (e.g., each of) the openings 316 may have a width 700 (e.g., a maximum width), in a direction perpendicular to a corresponding pair of the fins 304 (e.g., a circumferential direction), that is less than a distance 702 between the corresponding pair of the fins 304.

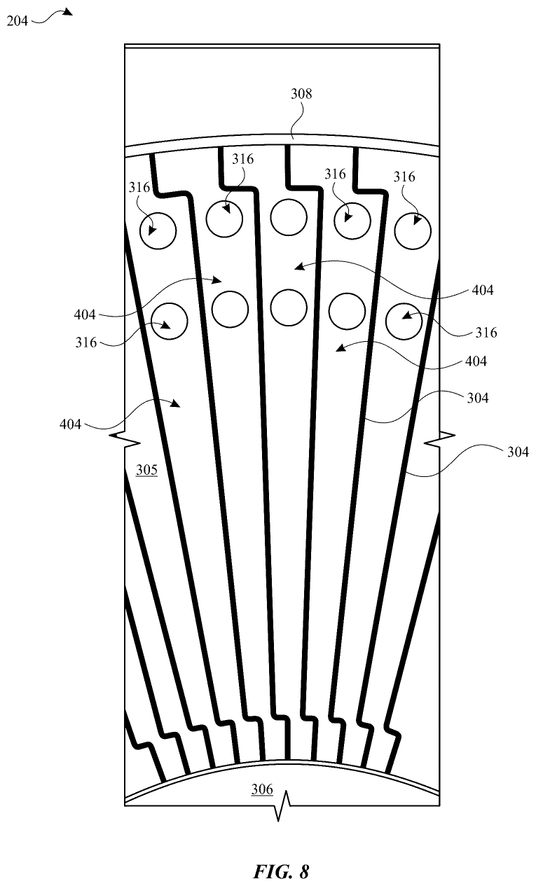

In the example of FIG. 7, the first substrate 305 includes one opening 316 in alignment with each space 404 between the fins 304. However, this is merely illustrative and, in other implementations, the first substrate 305 may include multiple openings 316 in alignment with each space 404 between the fins 304. For example, FIG. 8 illustrates an implementation in which the first substrate 305 includes two openings 316, radially spaced apart from each other, in alignment with each of the spaces 404 between the fins 304.

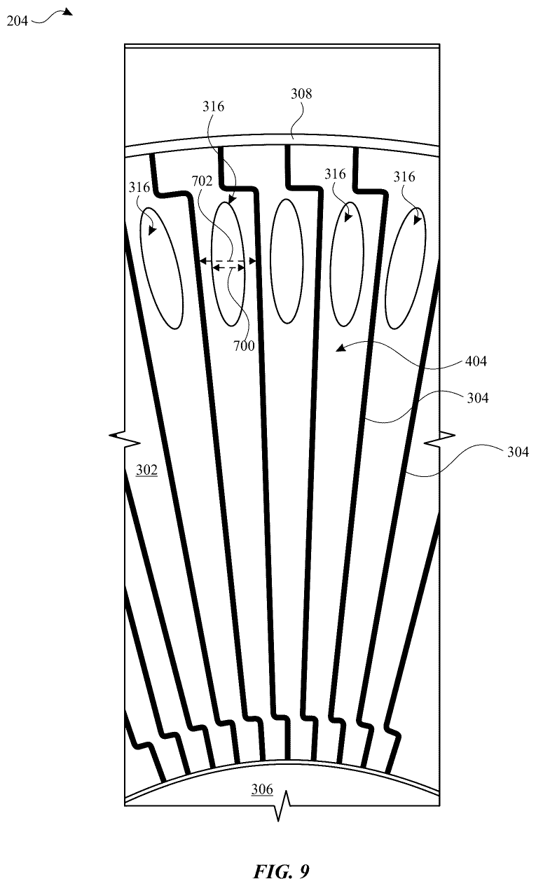

In the examples of FIGS. 7 and 8, the openings 316 are depicted as circular openings (e.g., openings having a circular cross-section), and the width 700 of each opening 316 corresponds to a diameter of that opening 316. However, in one or more other implementations, one or more of the openings 316 may have a shape other than a circular shape. For example, FIG. 9 illustrates an implementation in which the openings 316 have an elongate shape. In the example of FIG. 9, the width 700 is a largest width of the opening 316 along a circumferential direction (e.g., a direction perpendicular to a radial portion of the fins 304), and the openings 316 have a length along a radial direction that is greater than the width 700. The examples of FIGS. 7-9 are merely illustrative, and other arrangements and/or shapes of openings in the first substrate 305 can be used. It is also appreciated that, although some examples herein describe the operation of the MEMS component 300 in terms of pairs of the fins 304, fins 304 can be used in pairs or individually (e.g., as in FIG. 5) by organizing the openings 316 to match pressure maximum locations.

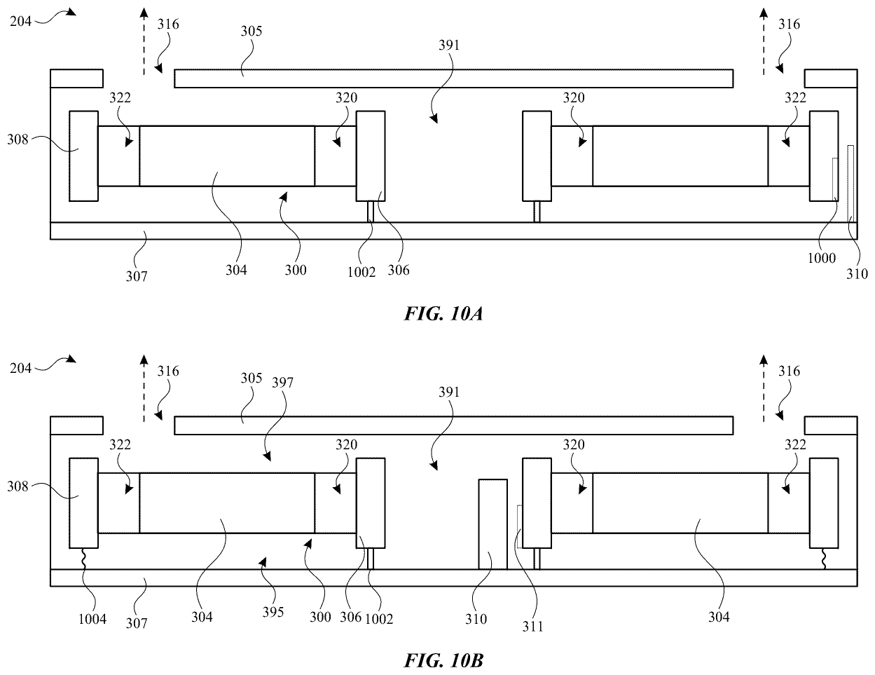

As discussed herein, in various implementations, the inner support structure 306 and/or the outer support structure 308 may be configured to rotate to actuate the fins 304. In the examples of FIGS. 4-7, the inner support structure 306 is configured to rotate to actuate the fins 304. FIG. 10A illustrates an implementation of the MEMS transducer 204 in which the inner support structure 306 is fixed, and the outer support structure 308 is configured to rotate. For example, in the implementation of FIG. 10A, the inner support structure 306 may be fixed to the second substrate 307 by a beam 1002 (or other attachment). As shown, the drive element 310 may be located outward of the outer support structure 308. In one or more implementations, the drive element 310 may include one or more electrodes configured to electrostatically interact with one or more electrodes 1000 of the outer support structure 308. The electrodes 1000 may be attached to the outer support structure 308, may be completely or partially embedded within the outer support structure, and/or may be integrally formed as part of the outer support structure 308.

In the example of FIG. 10A, air in the cavity 391 can flow between the fins 304 from the front side (e.g., a top side in the cross-sectional view of FIG. 10A) of the fins 304 across from which the first substrate 305 and the openings 316 are formed, and from a rear side (e.g., a bottom side in the cross-sectional view of FIG. 10A) of the fins 304 across from which the second substrate 307 is formed. FIG. 10B illustrates another example implementation of the MEMS transducer 204. As shown in FIG. 10B, in one or more implementations, a scaling feature 1004 may be provided that (e.g., along with the beam 1002) separates the cavity 391 into the back volume 395 on the rear side of the fins 304 and the front radiating cavity 397 on the front side of the fins 304. In the example of FIG. 10B, communication of the air between the fins 304 may have access to the cavity 391 only from the front side. In the example of FIG. 10B, the sealing feature 1004 includes a flexible membrane that seals the back volume 395 while allowing rotation of the outer support structure 308. However, this is merely illustrative, and any other sealing feature or mechanism can be used that that seals the back volume 395 while allowing rotation of the outer support structure 308 (e.g., including forming a lower surface of the outer beam at a height above the second substrate 307 that prevents or restricts air from flowing between the lower surface of the outer beam and the second substrate 307). The implementation of FIG. 10B may be beneficial, for example, when implementing the MEMS transducer 204 to generate ultrasonic frequencies.

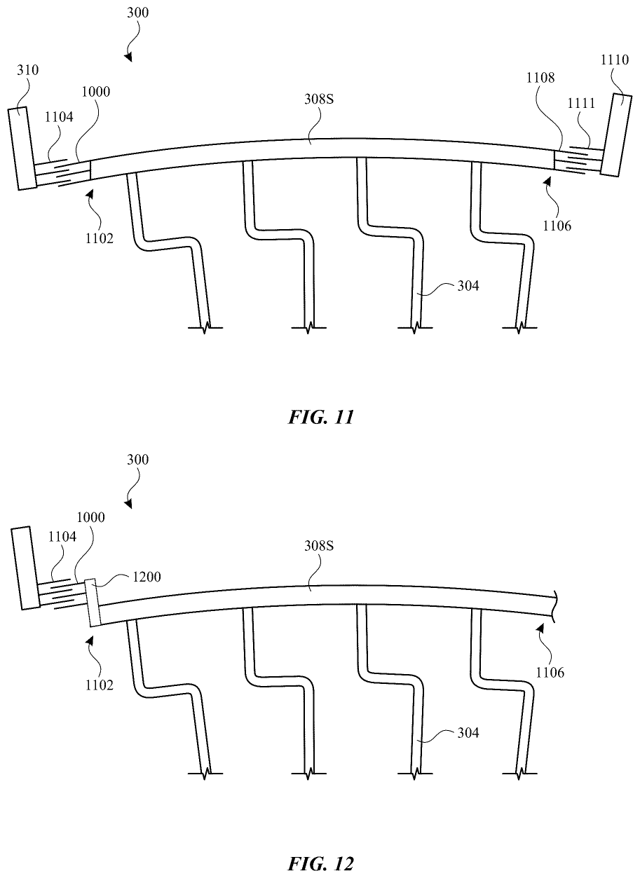

In one or more implementations, the drive element 310 may be implemented as a comb drive actuator. For example, FIG. 11 illustrates an implementation of a portion of the MEMS component 300 in which the drive element 310 includes a plurality of electrodes 1104 extending in parallel to each other and separated from each other by open-ended gaps. In this example, the outer support structure 308 may include multiple semi-cylindrical sections that each connect to a subset of the fins 304. In the example of FIG. 11, a semi-cylindrical section 308S of the outer support structure 308 is connected four fins 304 and includes a first end 1102 and a second end 1106. In various other implementations, the semi-cylindrical section 308S of the outer support structure 308 may be connected to less than four fins 304 or more than four fins 304 (e.g., ten or more fins 304). In one or more implementations, the outer support structure 308 may include multiple semi-cylindrical sections 308S around the periphery of the MEMS component 300, each connected to a respective subset of the fins 304.

In the example of FIG. 11, the electrodes 1104 of the drive element 310 are arranged opposite to and interposed with corresponding electrodes 1000 extending from the first end 1102 of the semi-cylindrical section 308S of the outer support structure 308 (e.g., into the open-ended gaps between the electrodes 1104). In this way, the electrodes 1104 of the drive element 310 may be arranged to pull and push the electrodes 1000 of the semi-cylindrical section 308S of the outer support structure 308 toward and away from the drive clement 310, thereby rotating the semi-cylindrical section 308S of the outer support structure 308 to move the fins 304, while also keeping the first end 1102 of the semi-cylindrical section 308S of the outer support structure 308 in alignment with the drive element 310.

In various implementations in which the outer support structure 308 includes multiple semi-cylindrical sections 308S, the MEMS transducer 204 may include a drive element at one end of each of the semi-cylindrical sections 308S, or may include drive elements at both ends of each semi-cylindrical section 308S of the outer support structure 308. For example, FIG. 11 also shows how a drive element 1110, implemented as a comb drive actuator, may include electrodes 1111 interposed with electrodes 1108 extending from the second end 1106 of the semi-cylindrical section 308S of the outer support structure 308.

In the example of FIG. 11, the electrodes 1000 and 1108 extend directly from the respective ends of the semi-cylindrical section 308S of the outer support structure 308. However, in one or more implementations, the electrodes of the semi-cylindrical section 308S of the outer support structure 308 may be coupled to the semi-cylindrical section 308S of the outer support structure 308 in other ways and/or at other locations. As one other example, FIG. 12 illustrates an implementation in which the semi-cylindrical section 308S of the outer support structure 308 includes a radial extension 1200. In this example, the radial extension 1200 extends from the first end 1102 of the semi-cylindrical section 308S of the outer support structure 308 and includes the electrodes 1000 in opposition to (e.g., and interposed with) the electrodes 1104 in the comb drive implementation of the drive element 310. In this example, the radial extension 1200 and electrodes 1000 are formed on a single end of the semi-cylindrical section 308S of the outer support structure 308. However, in other implementations, an additional extension with additional electrodes may be formed on the other end (e.g., second end 1106) of the semi-cylindrical section 308S of the outer support structure 308. The radial extension 1200 and/or the electrodes 1000 may be attached to the outer support structure 308 or may be integrally formed portions of the outer support structure 308.

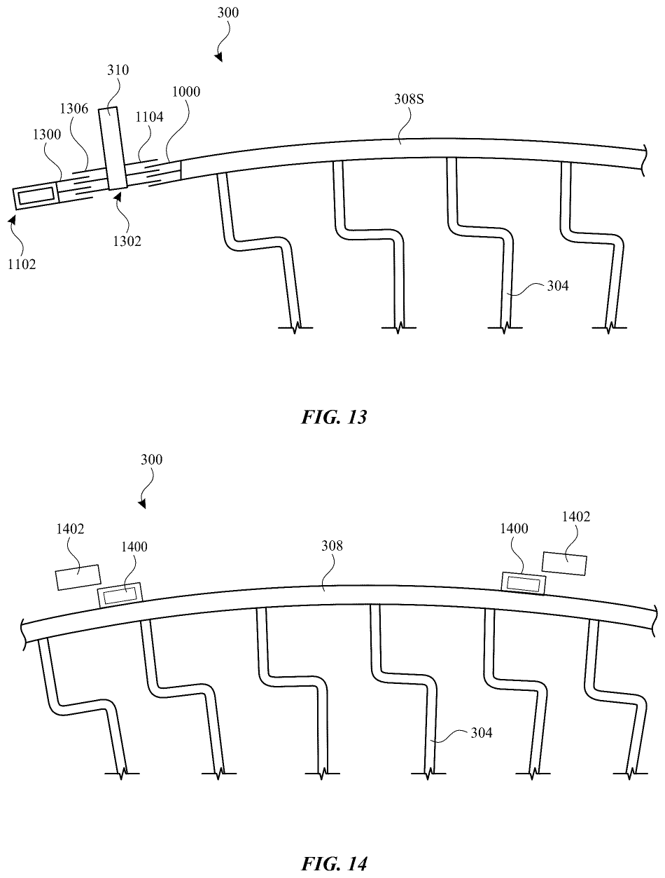

In the examples of FIGS. 11 and 12, the drive element 310 (and the drive element 1110) include electrodes extending in a single direction. However, in one or more other implementations, the drive element 310 (and/or the drive element 1110) may include electrodes extending from two opposing sides, as in the example of FIG. 13. In this example, the semi-cylindrical section 308S of the outer support structure 308 includes electrodes 1000 and electrodes 1300 extending in opposite directions, respectively, into a gap 1302 in the semi-cylindrical section 308S of the outer support structure 308. For example, the gap may be a recess along an end, such as a top end or a bottom end, of the semi-cylindrical section 308S of the outer support structure 308. In this example, the drive element 310 includes the electrodes 1104 extending in a first direction from the drive element 310 and interposed with the electrodes 1000, and also includes electrodes 1306 extending in a second direction from the drive element 310 and interposed with the electrodes 1300. In this example, the electrodes 1104 and 1306 may be used to drive the semi-cylindrical section 308S of the outer support structure 308 linearly or differentially.

The examples of FIGS. 11-13 in which the drive element 310 is implemented as a comb drive actuator are merely illustrative. In one or more other implementations, other arrangements of electrodes may be used to drive the rotation of the outer support structure 308. For example, FIG. 14 illustrates an example in which electrodes 1400 are disposed at various locations around the outer periphery of the outer support structure 308. In this example, electrodes 1402 that positioned in proximity to the electrodes 1400, respectively, can be energized (e.g., by the drive element 310) to cause rotations of the outer support structure 308. Although the examples of FIGS. 11-14 show drive element and electrode arrangements for driving rotation of the outer support structure 308, the drive element and electrode arrangements described in connection with any or all of FIGS. 11-14 can also, or alternatively, be used to drive rotation of the inner support structure 306.

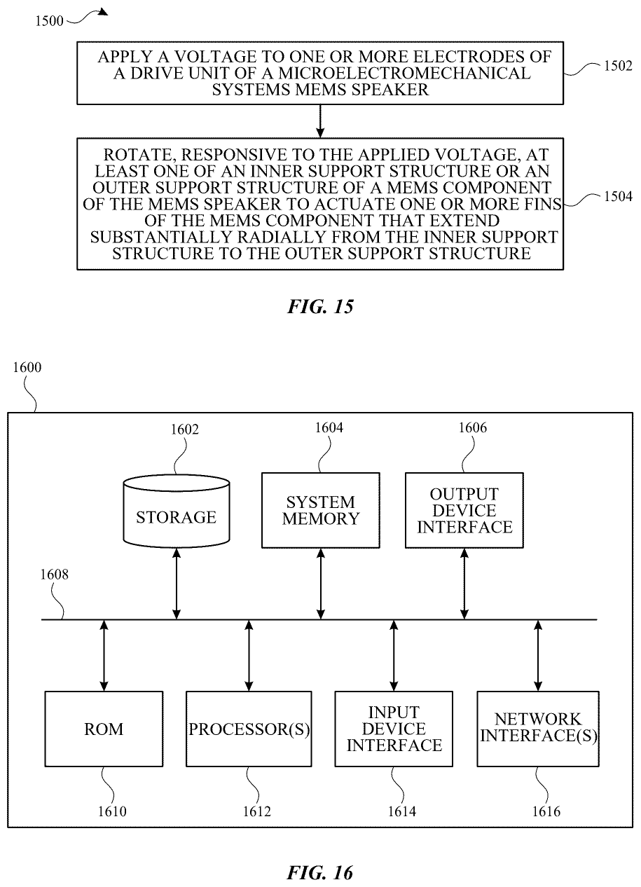

FIG. 15 illustrates a flow diagram of an example process for operating a MEMS speaker having a radial MEMS component in accordance with one or more implementations. For explanatory purposes, the process 1500 is primarily described herein with reference to the device 100 of FIG. 1 or the device 370 of FIG. 3. However, the process 1500 is not limited to device 100 of FIG. 1 or the device 370 of FIG. 3, and one or more blocks (or operations) of the process 1500 may be performed by one or more other components and other suitable devices (e.g., any electronic device including a MEMS speaker with a radial MEMS component as described herein). Further for explanatory purposes, the blocks of the process 1500 are described herein as occurring in serial, or linearly. However, multiple blocks of the process 1500 may occur in parallel. In addition, the blocks of the process 1500 need not be performed in the order shown and/or one or more blocks of the process 1500 need not be performed and/or can be replaced by other operations.

In the example of FIG. 15, at block 1502, a voltage may be applied to one or more electrodes (e.g., electrodes 1104, 1111, 1306, or 1402) of a drive unit (e.g., drive element 310) of a MEMS speaker (e.g., speaker 200). For example, the MEMS speaker may be implemented in an electronic device, such as the device 100 of FIG. 1 or the electronic device of FIG. 3. The drive unit may be implemented in a MEMS transducer (e.g., MEMS transducer 204) of the MEMS speaker.

At block 1504, at least one of an inner support structure (e.g., inner support structure 306) or an outer support structure (e.g., outer support structure 308) of a MEMS component of the MEMS speaker may be rotated responsive to the voltage applied to the one or more electrodes of the drive unit to actuate one or more fins (e.g., fins 304) of the MEMS component that extend radially from the inner support structure to the outer support structure. Rotating the inner support structure or the outer support structure may include the inner support structure or the outer support structure back and forth with various frequencies to generate various desired sounds with the MEMS component. Rotating the inner support structure or the outer support structure may generate pressure variations between the fins that move air to generate the sound for the MEMS speaker.

FIG. 16 illustrates an electronic system 1600 with which one or more implementations of the subject technology may be implemented. The electronic system 1600 can be, and/or can be a part of, one or more of the devices 100 or 370 shown in FIG. 1. The electronic system 1600 may include various types of computer readable media and interfaces for various other types of computer readable media. The electronic system 1600 includes a bus 1608, one or more processing unit(s) 1612, a system memory 1604 (and/or buffer), a ROM 1610, a permanent storage device 1602, an input device interface 1614, an output device interface 1606, and one or more network interfaces 1616, or subsets and variations thereof.

The bus 1608 collectively represents all system, peripheral, and chipset buses that communicatively connect the numerous internal devices of the electronic system 1600. In one or more implementations, the bus 1608 communicatively connects the one or more processing unit(s) 1612 with the ROM 1610, the system memory 1604, and the permanent storage device 1602. From these various memory units, the one or more processing unit(s) 1612 retrieves instructions to execute and data to process in order to execute the processes of the subject disclosure. The one or more processing unit(s) 1612 can be a single processor or a multi-core processor in different implementations.

The ROM 1610 stores static data and instructions that are needed by the one or more processing unit(s) 1612 and other modules of the electronic system 1600. The permanent storage device 1602, on the other hand, may be a read-and-write memory device. The permanent storage device 1602 may be a non-volatile memory unit that stores instructions and data even when the electronic system 1600 is off. In one or more implementations, a mass-storage device (such as a magnetic or optical disk and its corresponding disk drive) may be used as the permanent storage device 1602.

In one or more implementations, a removable storage device (such as a floppy disk, flash drive, and its corresponding disk drive) may be used as the permanent storage device 1602. Like the permanent storage device 1602, the system memory 1604 may be a read-and-write memory device. However, unlike the permanent storage device 1602, the system memory 1604 may be a volatile read-and-write memory, such as random access memory. The system memory 1604 may store any of the instructions and data that one or more processing unit(s) 1612 may need at runtime. In one or more implementations, the processes of the subject disclosure are stored in the system memory 1604, the permanent storage device 1602, and/or the ROM 1610. From these various memory units, the one or more processing unit(s) 1612 retrieves instructions to execute and data to process in order to execute the processes of one or more implementations.

The bus 1608 also connects to the input and output device interfaces 1614 and 1606. The input device interface 1614 enables a user to communicate information and select commands to the electronic system 1600. Input devices that may be used with the input device interface 1614 may include, for example, alphanumeric keyboards and pointing devices (also called “cursor control devices”). The output device interface 1606 may enable, for example, the display of images generated by electronic system 1600. Output devices that may be used with the output device interface 1606 may include, for example, printers and display devices, such as a liquid crystal display (LCD), a light emitting diode (LED) display, an organic light emitting diode (OLED) display, a flexible display, a flat panel display, a solid state display, a projector, or any other device for outputting information. One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

Finally, as shown in FIG. 16, the bus 1608 also couples the electronic system 1600 to one or more networks and/or to one or more network nodes through the one or more network interface(s) 1616. In this manner, the electronic system 1600 can be a part of a network of computers (such as a LAN, a wide area network (“WAN”), or an Intranet, or a network of networks, such as the Internet. Any or all components of the electronic system 1600 can be used in conjunction with the subject disclosure.

In accordance with some aspects of the subject disclosure, a speaker is provided that includes a microelectromechanical systems (MEMS) component, including: an inner support structure; an outer support structure; and a plurality of fins, each having at least a portion extending in a radial direction between a first end coupled to the inner support structure to a second end coupled to the outer support structure, at least one of the inner support structure or the outer support structure configured to rotate to actuate at least one of the first end or the second end of each of the plurality of fins to generate sound for the speaker.

In accordance with other aspects of the subject disclosure, an electronic device is provided that includes a microelectromechanical systems (MEMS) transducer, including: a radial MEMS component, including: an inner support structure; an outer support structure; and a plurality of fins, each including at least a portion that extends in a radial direction between a first end coupled to the inner support structure to a second end coupled to the outer support structure, at least one of the inner support structure or the outer support structure configured to rotate to actuate at least one of the first end or the second end of each of the plurality of fins to generate sound for the MEMS transducer.

In accordance with other aspects of the subject disclosure, a microelectromechanical systems (MEMS) component for a speaker is provided, the MEMS component including: an inner support structure; an outer support structure; and a plurality of fins, each including at least a portion that extends in a radial direction between a first end coupled to the inner support structure to a second end coupled to the outer support structure, at least one of the inner support structure or the outer support structure configured to rotate to move at least one of the first end or the second end of each of the plurality of fins to generate sound for the speaker.

In accordance with other aspects of the subject disclosure, a method of operating a speaker is provided, the method including applying a voltage to one or more electrodes of a drive element of a microelectromechanical systems (MEMS) speaker; and rotating, responsive to the applied voltage, at least one of an inner support structure or an outer support structure of a MEMS component of the MEMS speaker to actuate one or more fins of the MEMS component that extend radially from the inner support structure to the outer support structure.

Implementations within the scope of the present disclosure can be partially or entirely realized using a tangible computer-readable storage medium (or multiple tangible computer-readable storage media of one or more types) encoding one or more instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessor or multi-core processors that execute software, one or more implementations are performed by one or more integrated circuits, such as ASICs or FPGAs. In one or more implementations, such integrated circuits execute instructions that are stored on the circuit itself.

Various functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself.

As used in this specification and any claims of this application, the terms “computer”, “processor”, and “memory” all refer to electronic or other technological devices. These terms exclude people or groups of people. For the purposes of the specification, the terms “display” or “displaying” means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

Many of the above-described features and applications are implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some implementations, multiple software aspects of the subject disclosure can be implemented as sub-parts of a larger program while remaining distinct software aspects of the subject disclosure. In some implementations, multiple software aspects can also be implemented as separate programs. Finally, any combination of separate programs that together implement a software aspect described here is within the scope of the subject disclosure. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Some of the blocks may be performed simultaneously. For example, in certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

The predicate words “configured to”, “operable to”, and “programmed to” do not imply any particular tangible or intangible modification of a subject, but, rather, are intended to be used interchangeably. For example, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

The word “example” is used herein to mean “serving as an example or illustration.” Any aspect or design described herein as “example” is not necessarily to be construed as preferred or advantageous over other aspects or design.

In one aspect, a term coupled or the like may refer to being directly coupled. In another aspect, a term coupled or the like may refer to being indirectly coupled.

Terms such as top, bottom, front, rear, side, horizontal, vertical, and the like refer to an arbitrary frame of reference, rather than to the ordinary gravitational frame of reference. Thus, such a term may extend upwardly, downwardly, diagonally, or horizontally in a gravitational frame of reference.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112 (f), unless the element is expressly recited using the phrase “means for” or, in the case of a method claim, the element is recited using the phrase “step for.” Furthermore, to the extent that the term “include,” “have,” or the like is used in the description or the claims, such term is intended to be inclusive in a manner similar to the term “comprise” as “comprise” is interpreted when employed as a transitional word in a claim.

What is claimed is:

1. A speaker, comprising:
a microelectromechanical systems (MEMS) component, comprising:
an inner support structure;
an outer support structure; and
a plurality of fins, each including at least a portion extending in a radial direction between a first end coupled to the inner support structure to a second end coupled to the outer support structure,
wherein at least one of the inner support structure or the outer support structure is configured to rotate to actuate at least one of the first end or the second end of each of the plurality of fins to generate sound for the speaker.

2. The speaker of claim 1, further comprising a first substrate on a first side of the MEMS component and a second substrate on a second side of the MEMS component, wherein the second substrate sealingly encloses the second side of the MEMS component, and wherein the first substrate comprises a plurality of openings configured to allow the sound generated by the plurality of fins to exit the speaker.

3. The speaker of claim 2, wherein the MEMS component comprises a plurality of spaces, each space disposed between a pair of the plurality of fins, and wherein the plurality of openings in the first substrate comprise at least one opening adjacent to each of the plurality of spaces in the MEMS component.

4. The speaker of claim 3, wherein each of the plurality of openings has a width, in a direction perpendicular to a corresponding pair of the plurality of fins, that is less than a distance between the corresponding pair of the plurality of fins.

5. The speaker of claim 2, wherein the radial direction is substantially parallel to the first substrate and the second substrate.

6. The speaker of claim 1, wherein the inner support structure comprises a substantially cylindrical inner support structure and the outer support structure comprises a substantially cylindrical outer support structure positioned coaxially around the substantially cylindrical inner support structure.

7. The speaker of claim 1, wherein the MEMS component comprises a unitary contiguous structure including the inner support structure, the outer support structure, and the plurality of fins.

8. The speaker of claim 1, wherein the outer support structure is fixed and wherein the inner support structure is configured to rotate.

9. The speaker of claim 1, wherein the inner support structure is fixed and wherein the outer support structure is configured to rotate.

10. The speaker of claim 1, further comprising at least one electrode configured to cause the at least one of the inner support structure or the outer support structure to rotate.

11. A microelectromechanical systems (MEMS) component for a speaker, the MEMS component comprising:
an inner support structure;
an outer support structure; and
a plurality of fins, each including at least a portion that extends in a radial direction between a first end coupled to the inner support structure to a second end coupled to the outer support structure,
wherein at least one of the inner support structure or the outer support structure is configured to rotate to move at least one of the first end or the second end of each of the plurality of fins to generate sound for the speaker.

12. The speaker of claim 1, wherein each of the plurality of fins comprises a first jog and a second jog.

13. The MEMS component of claim 12, wherein the first jog is larger than the second jog.

14. The MEMS component of claim 13, wherein the first jog is nearer to the second end than the first end, and wherein the second jog is nearer to the first end than the second end.

15. The MEMS component claim 11, wherein the inner support structure comprises a substantially cylindrical inner support structure and the outer support structure comprises a substantially cylindrical outer support structure positioned coaxially with the substantially cylindrical inner support structure.

16. The MEMS component of claim 11, wherein the MEMS component comprises a unitary contiguous structure including the inner support structure, the outer support structure, and the plurality of fins.

17. The MEMS component of claim 11, wherein the outer support structure is fixed and wherein the inner support structure is configured to rotate.

18. An electronic device, comprising:
a microelectromechanical systems (MEMS) transducer, comprising:
a radial MEMS component, comprising:
an inner support structure;
an outer support structure; and
a plurality of fins, each including at least a portion that extends in a radial direction between a first end coupled to the inner support structure to a second end coupled to the outer support structure,
wherein at least one of the inner support structure or the outer support structure is configured to rotate to actuate at least one of the first end or the second end of each of the plurality of fins to generate sound for the MEMS transducer.

19. The electronic device of claim 18, wherein the MEMS transducer further comprises a first substrate on a first side of the radial MEMS component and a second substrate on a second side of the radial MEMS component, wherein the second substrate sealingly encloses the second side of the radial MEMS component, and wherein the first substrate comprises a plurality of openings configured to allow the sound generated by the plurality of fins to exit the MEMS transducer.

20. The electronic device of claim 19, wherein the MEMS transducer comprises a first MEMS transducer unit in a speaker having a one or more additional MEMS transducer units.

21. A method, comprising:
applying a voltage to one or more electrodes of a drive element of a microelectromechanical systems (MEMS) speaker; and
rotating, responsive to the applied voltage, at least one of an inner support structure or an outer support structure of a MEMS component of the MEMS speaker to actuate one or more fins of the MEMS component that extend radially from the inner support structure to the outer support structure.
